(19) United States
(12) Patent Application Publication
(10) Pub. No.: US 2020/0407881 A1
(43) Pub. Date: Dec. 31, 2020

(54) Apparatus For Producing Ultrafine Fibers

(71) Applicant: JXTG Nippon Oil & Energy Corporation, Tokyo (JP)

(72) Inventors: Taku Ichibayashi, Tokyo (JP); Yoshihiro Kumagai, Tokyo (JP)

(73) Assignee: JXTG Nippon Oil & Energy Corporation, Tokyo (JP)

(21) Appl. No.: 16/625,393

(22) PCT Filed: Jun. 28, 2018
(86) PCT No.: PCT/JP2018/024581

§ 371 Date: Dec. 20, 2019

(30) Foreign Application Priority Data
Jun. 28, 2017 (JP) 2017-126326

(51) Int. Cl. D01D 5/098; D01D 5/14; D01F 6/06; D01F 6/30; D01D 10/02; D02J 1/22; B23K 26/00; B23K 26/064; B23K 26/354

(52) U.S. Cl. CPC D01D 5/0985; D01D 5/14; D01F 6/06; D01F 6/30; B23K 26/354; D02J 1/22; B23K 26/0006; B23K 26/064; D01D 10/02

(57) ABSTRACT

An apparatus for producing ultrafine fibers is configured to produce ultrafine fibers by melting and drawing raw filaments. The apparatus for producing ultrafine fibers comprises: a plurality of raw filament passages arranged in a straight row; and a laser irradiation device for irradiating a plurality of raw filaments with a laser beam so as to melt, oscillate and vibrate the plurality of raw filaments after the plurality of raw filaments have passed through the respective raw filament passages together with airstreams. Specifically, the laser irradiation device is configured to output a focused laser beam having a diameter decreasing as distance from the laser irradiation device increases, and having a beam axis parallel to a direction of the row of the plurality of raw filament passages.

### TECHNICAL FIELD

The present invention relates to an apparatus for producing ultrafine fibers.

### BACKGROUND ART

Patent Document 1 discloses a multi-spindle drawing machine for ultrafine filaments, which is a well-known example of apparatuses for producing ultrafine fibers. The multi-spindle drawing machine for ultrafine filaments includes a plurality of orifices, a laser beam irradiation device, and a beam shaping element. The multi-spindle drawing machine for ultrafine filaments is configured to cause the beam shaping element to convert a laser beam emitted from the laser beam irradiation device into a flat-top beam, and to position a plurality of filaments that have passed through the plurality of orifices so as not to overlap each other in the laser beam irradiation direction.

### REFERENCE DOCUMENT LIST

### Patent Document

Patent Document 1: JP 5696329 B

### SUMMARY OF THE INVENTION

### Problem to be Solved by the Invention

However, beam shaping elements for converting a laser beam into a flat-top beam are generally expensive. This inevitably increases the cost of the multi-spindle drawing machine for ultrafine filaments as a whole, and this is problematic. In addition, typically, a beam shaping element provides a laser beam having intended properties merely at the image formation position of the beam shaping element, so that the resultant laser beam has power levels less than intended at positions in front and back of the image formation position in the laser beam traveling direction. Accordingly, the multi-spindle drawing machine for ultrafine filaments is merely allowed to include a limited number of orifices, and thus, is merely capable of producing a limited number of ultrafine filaments, which is also problematic.

In view of the above, the present invention has been made to provide an apparatus for producing ultrafine fibers capable of reliably producing a larger number of ultrafine fibers than conventional related apparatuses without significantly increasing cost.

### Means for Solving the Problem

According to one aspect, the present invention provides an apparatus for producing ultrafine fibers, configured to produce ultrafine fibers by melting and drawing raw filaments. The apparatus for producing ultrafine fibers comprises: a plurality of raw filament passages arranged in a straight row; and a laser irradiation device for irradiating a plurality of raw filaments with a laser beam so as to melt, oscillate and vibrate the plurality of raw filaments after the plurality of raw filaments have passed through the respective raw filament passages together with airstreams. Specifically, the laser irradiation device is configured to output a focused laser beam having a diameter decreasing as distance from the laser irradiation device increases, and having a beam axis parallel to a direction of the row of the plurality of raw filament passages.

### Effects of the Invention

In the above apparatus for producing ultrafine fibers, the laser irradiation device for irradiating the plurality of raw filaments with a laser beam after the plurality of raw filaments have passed through the respective raw filament passages is configured to output a focused laser beam having a diameter decreasing as the distance from the laser irradiation device increases, and having a beam axis parallel to the direction of the row of the raw filament passages. This allows the raw filaments to be irradiated with the laser beam at substantially equalized power densities by compensating for laser power reductions caused by the oscillated and vibrated raw filaments. Thus, the apparatus for producing ultrafine fibers is capable of reliably producing a plurality of ultrafine fibers. Furthermore, the laser irradiation device is simply required to output a focused laser beam. Accordingly, the laser irradiation device may be simply made of components including an optical element using common spherical lenses and may thus be manufactured with no significant additional cost.

### BRIEF DESCRIPTION OF THE DRAWINGS

FIG. 1 shows a schematic configuration of an apparatus for producing ultrafine fibers according to an embodiment of the present invention.

FIG. 2 is a cross-sectional view showing a schematic configuration of an example of a raw filament passage in the apparatus for producing ultrafine fibers.

FIG. 3 shows a schematic configuration of an example of a laser irradiation device used in the apparatus for producing ultrafine fibers.

FIG. 4 is a schematic view of a portion, near the raw filament passages, of the apparatus for producing ultrafine fibers, for illustrating a laser beam (focused beam) output from the laser irradiation device.

FIG. 5 is a table showing comparison results of Examples and Comparative Examples.

### MODE FOR CARRYING OUT THE INVENTION

Hereinafter, an embodiment of the present invention will be described with reference to the drawings. FIG. 1 shows a schematic configuration of an apparatus for producing ultrafine fibers according to the embodiment of the present invention. An apparatus 1 for producing ultrafine fibers according to the embodiment is configured to produce ultrafine fibers by melting and drawing raw filaments. As used herein, the “ultrafine fibers” principally, but not exclusively, refers to so-called nanofibers having an average diameter (average fiber diameter) of less than 1 μm, and may include fibers having an average diameter of less than 10 μm.

The raw filaments are made of a thermoplastic resin processable into threads. Examples of such thermoplastic resins include: polyester resins such as polyethylene terephthalate, polytrimethylene terephthalate, polybutylene terephthalate, polyethylene naphthalate, polylactic acid, polyglycolic acid, and polyarylate, polyamide resins such as nylons (nylon 6, nylon 12, and nylon 66) and aromatic polyamides, polyolefin resins such as polypropylene and polyethylene, polyvinyl alcohol polymers such as ethylene-vinyl alcohol copolymers and ethylene-vinyl acetate copolymers, polyacrylonitrile polymers, fluorinated polymers such as tetrafluoroethylene-perfluoroalkyl vinyl ether copolymers (PFAs), ethylene-tetrafluoroethylene copolymers, tetrafluoroethylene-hexafluoropropylene copolymers, and polyvinylidene fluoride, polyurethane polymers, polyvinyl chloride polymers such as polyvinyl chloride and polyvinylidene chloride, polystyrene polymers such as polystyrene and syndiotactic polystyrene, poly(meth)acrylic polymers such as polymethacrylate methyl, polyoxymethylene, ether-ester polymers, cellulose polymers such as cellulose acetate, cellulose acetate propionate, and cellulose acetate butyrate, engineering plastics such as polyurethane resins, polyacetal resins, polycarbonate resins, modified polyphenylene ether resins, polyphenylene sulfide resins, polysulfone resins, polyethersulfone resins, polyetherketone resins, polyimide resins, polyetherimide resins, and liquid crystal polymers (LCPs). Examples of the thermoplastic resins for the raw filaments may further include any combination of the above polymers and/or may optionally contain one or more additives such as a plasticizer, a surfactant and an antioxidant. Among others, polyethylene terephthalate, polylactic acid, nylons (nylon 6 and nylon 66), and polypropylene are especially suitable for use in production of ultrafine fibers due to their good drawing and molecular orientation properties.

In this embodiment, multifilaments are used as the raw filaments. As used herein, the “multifilament” refers to a bundle of monofilaments. Specifically, multifilaments each including a bundle of 10 or more monofilaments are used as the raw filaments. The diameter of the monofilaments constituting each raw filament may preferably be, but not particularly limited to, in the range of 10 to 200 μm. In each raw filament, the bundle of the monofilaments may, for example, be twisted together so as to maintain its integrity.

As shown in FIG. 1, the apparatus 1 for producing ultrafine fibers according to the embodiment includes a feed chamber 5, a drawing chamber 7, and a laser irradiation device 9. In the feed chamber 5, a raw filament feeder 3 is disposed. In the drawing chamber 7, which is disposed below the feed chamber 5, raw filaments are drawn. The laser irradiation device 9 is disposed external to the drawing chamber 7. The feed chamber 5 and the drawing chamber 7 communicate with each other through a plurality of raw filament passages 11₁ to 11ₙ such as orifices and nozzles. The raw filament passages 11₁ to 11ₙ are adapted to allow raw filaments to pass therethrough. In this embodiment, the plurality of raw filament passages 11₁ to 11ₙ are arranged in a straight row at regular intervals. The laser irradiation device 9 may alternatively be disposed in the drawing chamber 7.

The pressure P1 in the feed chamber 5 is set higher than the pressure P2 in the drawing chamber 7. The difference ΔP (P1−P2) of the pressure P1 of the feed chamber 5 (i.e., the inlet pressure of the raw filament passages 11₁ to 11ₙ) and the pressure P2 of the drawing chamber 7 (i.e., the outlet pressure of the raw filament passages 11₁ to 11ₙ) may be set as desired in accordance with the specifications of the apparatus 1 for producing ultrafine fibers, and may preferably be 20 kPa or more, and more preferably be 50 kPa or more. It is particularly preferable that the pressure P1 of the feed chamber 5 be set to atmospheric pressure, and the pressure P2 of the drawing chamber 7 be set to a pressure lower than atmospheric pressure. This is because the above pressure setting allows a simpler structure of the apparatus 1 for producing ultrafine fibers (particularly, of the feed chamber 5). Typically, the temperatures of the feed chamber 5 and the drawing chamber 7 are set to room temperature (ordinary temperature).

The raw filament feeder 3 is configured to feed raw filaments to the respective raw filament passages 11₁ to 11ₙ. In this embodiment, the raw filament feeder 3 is further configured to feed the raw filaments at a variable speed. The raw filament feeder 3 includes a plurality (the same number as the raw filament passages 11₁ to 11ₙ) of feed reels 31₁ to 31ₙ, a plurality of delivery units 32₁ to 32ₙ, and a driver unit (not shown). A raw filament is wound around each of the feed reels 31₁ to 31ₙ. The delivery units 32₁ to 32ₙ, each of which is formed of a pair of delivery rollers, deliver the raw filaments fed from the feed reels 31₁ to 31ₙ to the inlets of the raw filament passages 11₁ to 11ₙ. The driver unit is configured to drive at least one of the delivery rollers of each pair. Specifically, the driver unit is configured to drive at least one of the delivery rollers of each pair at a variable speed, thereby making the feed speed of the raw filaments variable. However, the present invention is not limited to this, as long as the raw filament feeder 3 is configured to feed raw filaments individually to the respective raw filament passages 11₁ to 11ₙ.

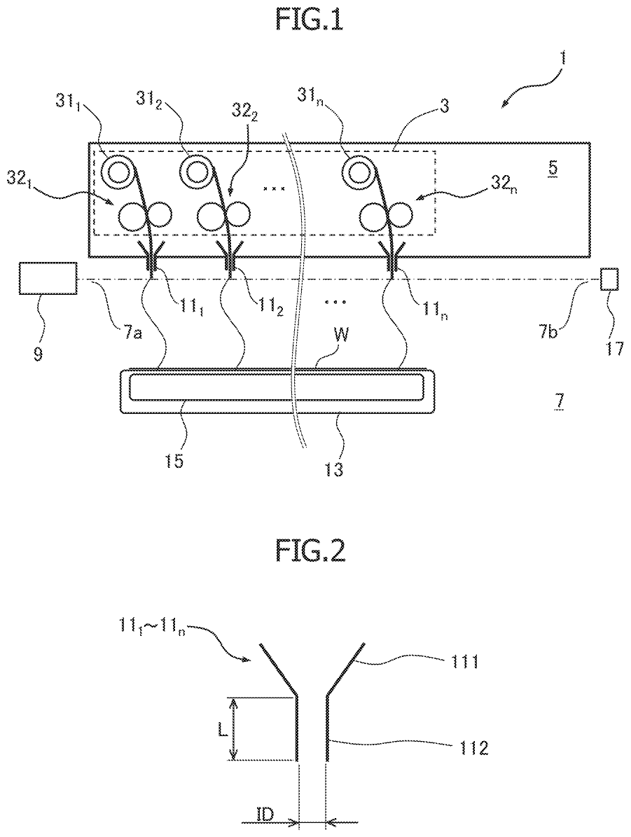

FIG. 2 is a cross-sectional view showing a schematic configuration of an example of each of the raw filament passages 11₁ to 11ₙ. As shown in FIG. 2, in this embodiment, each of the raw filament passages 11₁ to 11ₙ has a tapered entrance portion 11₁ and a straight tubular straightening portion 112. The entrance portion 11₁ is disposed closer to the feed chamber 5. The straightening portion 112 extends from the entrance portion 11₁ to the interior of the drawing chamber 7. According to this embodiment, in each of the raw filament passages 11₁ to 11ₙ, the ratio (LID) of the length L of the straightening portion 112 to the inner diameter ID of the straightening portion 112 is in the range of 0.1 to 100, preferably in the range of 0.5 to 50, more preferably in the range of 1 to 10.

As described above, the pressure P1 in the feed chamber 5 is set higher than the pressure P2 in the drawing chamber 7. This generates an airstream from the feed chamber 5 to the drawing chamber 7 in each of the raw filament passages 11₁ to 11ₙ. After the raw filaments are fed into (the inlets of) the raw filament passages 11₁ to 11ₙ by the raw filament feeder 3 in the feed chamber 5, the raw filaments pass through the raw filament passages 11₁ to 11ₙ together with the airstreams, and are thereby led to the drawing chamber 7. When the raw filaments pass through the raw filament passages 11₁ to 11ₙ, a high-speed airstream is generated in the gap between the outer peripheral surface of each of the raw filaments and the inner peripheral surface of the straightening portion 112 of the corresponding one of the raw filament passages 11₁ to 11ₙ and such high-speed airstreams are jetted into the drawing chamber 7 from the outlets of the raw filament passages 11₁ to 11ₙ. Here, the intensity of such high-speed airstreams depends on the pressure difference (P1−P2) between the pressure P1 in the feed chamber 5 and the pressure P2 in the drawing chamber 7.

To allow appropriate high-speed airstream generation in the gap between the outer peripheral surface of each of the raw filaments and the inner peripheral surface of the straightening portion 112 of the corresponding one of the raw filament passages 11₁ to 11ₙ, the ratio S2/S1 of the cross-sectional area S2 of each raw filament to the cross-sectional area S1 of the straightening portion 112 of each of the raw filament passages 11₁ to 11ₙ needs to be in the range of 5 to 50%, preferably 10 to 35% (The ratio S2/S1 will be referred to as “raw filament coverage ratio” below). As such, the diameter and number of monofilaments constituting each raw filament are adjusted appropriately in accordance with the properties (inner diameter ID of the straightening portions 112) of the raw filament passages 11₁ to 11ₙ so that the raw filament coverage ratio falls within the above range.

After the raw filaments have passed through the respective raw filament passages 11₁ to 11ₙ together with the airstreams and then entered the drawing chamber 7, the laser irradiation device 9 irradiates the raw filaments with a laser beam through a light transmissive portion 7a formed in the drawing chamber 7. Here, as described above, high-speed airstreams are jetted from the outlets of the raw filament passages 11₁ to 11ₙ. Thus, while the raw filaments are melted under laser irradiation by the laser irradiation device 9, each raw filament is oscillated and vibrated randomly in a substantially conical space having an apex located near the outlet of the corresponding raw filament passage, and drawn by the high-speed airstream jetted from the outlet of the corresponding raw filament passage. In this way, the apparatus 1 for producing ultrafine fibers produces a plurality of ultrafine fibers from a plurality of raw filaments. The configuration, operation, and the like of the laser irradiation device 9 will be described later.

In this embodiment, the plurality of ultrafine fibers produced as described above are accumulated on the conveyor 13 that is disposed in the drawing chamber 7 below the plurality of raw filament passages 11₁ to 11ₙ and thereby formed into a web (nonwoven fabric) W, and the conveyor 13 conveys the web W in the near-to-far direction of FIG. 1 orthogonal to the plane of FIG. 1. In this event, the web W resulting from ultrafine fiber accumulation on the conveyor 13 should preferably be drawn from behind the conveyor 13 by, for example, a negative-pressure suction device 15 so as to maintain the web W stable on the conveyor 13. While being conveyed by the conveyor 13, the web W may be subjected to heat treatment as necessary. After that, the web W is wound around a winding roller (not shown).

In this embodiment, in order to prevent the oscillated and vibrated raw filaments from coming into contact with each other as well as to ensure the homogeneity of the web (nonwoven fabric) resulting from ultrafine fiber accumulation on the conveyor 13, the distance between each adjacent two raw filament passages (intervals between the raw filament passages) is set to fall within the range from 1 mm to 25 mm, inclusive. In FIG. 1, the direction of the row of the raw filament passages 11₁ to 11ₙ is orthogonal to the direction in which the web W is conveyed by the conveyor 13. However, the present invention is not limited to this, and the direction of the row of the raw filament passages 11₁ to 11ₙ may be set as desired within a range of 90°±45° with respect to the direction of conveying the web W.

Next, the laser irradiation device 9 will be described in more detail. In this embodiment, the laser irradiation device 9 is configured to irradiate the raw filaments with a laser beam so that a molten portion of each raw filament is located at a distance of 1 mm or more and 10 mm or less vertically below the outlet of the corresponding raw filament passage. This aims at allowing each raw filament to be oscillated and vibrated within a predetermined region, and allowing the high-speed airstreams jetted from the raw filament passages to effectively draw the respective raw filaments. Each predetermined region spans an angular range of 5° to 80°, preferably 15° to 50°, more preferably 20° to 40° with respect to the central axis of the corresponding raw filament passage.

In this embodiment, after having passed through the raw filament passages 11₁ to 11ₙ, the raw filaments are irradiated with a laser beam output from the laser irradiation device 9, thereby melted, and oscillated and vibrated. As such, the power of the laser beam output from the laser irradiation device 9 decreases stepwise at the locations corresponding to raw filament passages 11₁ to 11ₙ so that the laser beam maintains a substantially uniform power distribution over its entire cross section rather than the power of the laser beam being locally reduced to have a nonuniform power distribution over the cross section. Furthermore, since the raw filaments are oscillated and vibrated in the same manner with each other, the power reduction amounts of the laser beam at the respective locations corresponding to the raw filament passages 11₁ to 11ₙ are substantially equal to each other. In addition, in this embodiment, the raw filament passages 11₁ to 11ₙ are arranged at regular intervals. Considering the above, it may be understood that, in this embodiment, the laser beam output from the laser irradiation device 9 has characteristics of attenuating substantially proportionally to the distance from the laser irradiation device 9 in a spinning region where the raw filaments that have passed through the raw filament passages 11₁ to 11ₙ are formed into ultrafine fibers.

Accordingly, by setting the diameter of the laser beam output from the laser irradiation device 9 in accordance with the attenuation characteristics as described above, that is, by reducing the beam diameter as the distance from the laser irradiation device 9 increases, it is possible to equalize the power densities of the laser beam at the respective locations corresponding to the raw filament passages 11₁ to 11ₙ; that is, it is possible to irradiate the raw filaments that have entered the drawing chamber 7 with the laser beam at equalized power densities. Furthermore, irradiating the raw filaments with the laser beam at equalized power densities allows a significant reduction of variation among the ultrafine fibers produced from the raw filaments. As used herein, the term “equalize/equalization” is not to be necessarily interpreted in a strict sense, but merely refers to the act of achieving a substantially equalized state. In a non-limiting example, the equalization level of the power densities of the laser beam at the locations corresponding to the raw filament passages 11₁ to 11ₙ may be represented by a ratio R of the minimum value to the maximum value of the power densities of the laser beam (i.e., R=“minimum power density”/“maximum power density”), and the ratio R may be 0.7 or more, preferably 0.8 or more.

In view of the above, in this embodiment, the laser irradiation device 9 is configured to output a laser beam having a beam axis parallel to the direction of the row of the raw filament passages 11₁ to 11ₙ and having a focusing property that allows the diameter of the laser beam to decrease as the distance from the laser irradiation device 9 increases (a laser beam having such a focusing property will be referred to as “focused beam” below). More specifically, the laser irradiation device 9 is configured to output a focused beam that travels in parallel to the direction of the row of the raw filament passages 11₁ to 11ₙ, and that has a beam axis passing across the axes of the raw filament passages at locations spaced a predetermined distance (in the range of 1 mm to 10 mm in this embodiment) from the outlets of the raw filament passages, and that has a focusing property that compensates for laser power reductions caused by the oscillated and vibrated raw filaments.

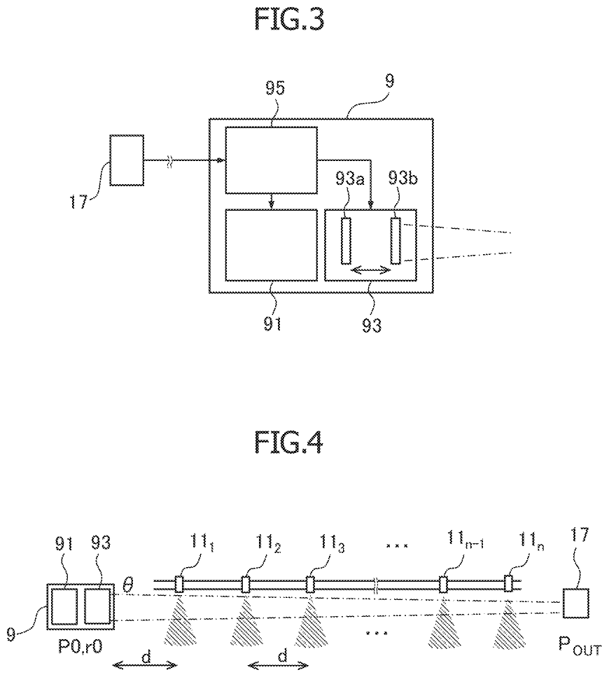

FIG. 3 shows a schematic configuration of an example of the laser irradiation device 9. As shown in FIG. 3, in this embodiment, the laser irradiation device 9 includes a laser oscillator 91, a beam converter 93, and a controller 95.

An example of the laser oscillator 91 is a carbon dioxide laser oscillator. The laser oscillator 91 is configured to emit a laser beam (Gaussian beam) parallel to the direction of the row of the raw filament passages 11₁ to 11ₙ. In this embodiment, the laser oscillator 91 is configured such that at least one of the power and diameter of the laser beam emitted therefrom is variable.

The beam converter 93 is configured to convert a laser beam emitted from the laser oscillator 91 into a focused beam as described above; that is, a focused beam with a focusing property that allows the diameter of the laser beam to decrease as the distance from the laser oscillator 91 (laser irradiation device 9) increases, and that compensates for laser power reductions caused by the oscillated and vibrated raw filaments. In this embodiment, the beam converter 93 includes an entrance lens 93a and an exit lens 93b, and is configured such that the focusing property of the focused beam is variable by adjustment of the distance between the entrance lens 93a and the exit lens 93b. However, the present invention is not limited to this, and the beam converter 93 may include three or more lenses (for example, one fixed lens and two movable lenses), and may be configured to convert a laser beam emitted from the laser oscillator 91 into a focused beam as described above so that the diameter and focusing property of the focused beam are variable by adjustment of the distance between the lenses. An example of the beam converter 93 is a so-called variable beam expander.

The controller 95 is configured to specify or change the conditions of the laser oscillator 91 and the beam converter 93 based on an input operation made by an operator or the like via an input unit (not shown). Specifically, the controller 95 is able to adjust the power, diameter (output diameter), focusing angle, and the like of the laser beam output from the laser irradiation device 9 based on an input operation of an operator or the like.

In this embodiment, the controller 95 is configured to control the laser oscillator 91 based on the power of the laser beam measured by a light power sensor 17. The light power sensor 17 is disposed at a position facing the laser irradiation device 9 across the drawing chamber 7; that is, across the raw filament passages 11₁ to 11ₙ (see FIG. 1). The light power sensor 17 is configured to measure the power P_{OUT} of the laser beam that has passed through a light transmissive portion 7b formed in the drawing chamber 7 after being output from the laser irradiation device 9 and then transmitted across the oscillated and vibrated raw filaments (The power of such a laser beam will be referred to as “power after transmission” below). An example of the light power sensor 17 is a so-called power meter.

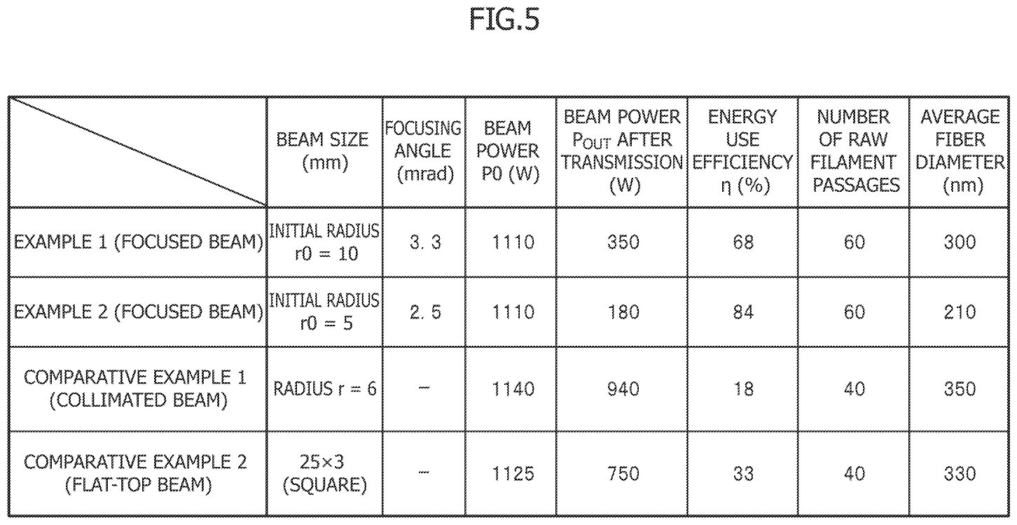

Next, the focused beam output from the laser irradiation device 9 will be described with reference to FIG. 4. FIG. 4 is a schematic view of a portion, near the raw filament passages 11₁ to 11ₙ, of the apparatus 1 for producing ultrafine fibers. In this embodiment, the distance from the laser irradiation device 9 to the raw filament passage 11₁, which is the closest of the raw filament passages 11₁ to 11ₙ to the laser irradiation device 9, is set equal to the intervals between the raw filament passages.

As shown in FIG. 4, P0 (W) represents the power of the focused beam upon being output from the laser irradiation device 9 (i.e., the power of the laser beam upon being emitted from the laser oscillator 91), r0 (mm) represents the initial radius of the focused beam immediately after being output from the laser irradiation device 9 (i.e., the radius of the laser beam upon being emitted from the laser oscillator 91 in this embodiment), θ (mrad) represents a focusing angle of the focused beam output from the laser irradiation device 9, d (mm) represents the intervals between the raw filament passages, and δ (W per filament) represents a power reduction amount of the laser beam caused by oscillation and vibration of each raw filament. The radius of the laser beam is measured at 1/e² of the peak.

While the apparatus 1 for producing ultrafine fibers is in operation, the raw filament that has passed through the raw filament passage 11₁, which is the closest of the raw filament passages 11₁ to 11ₙ to the laser irradiation device 9, is irradiated with the focused beam having a power P1, a radius r1, and a power density D1 as defined using simple geometric optics in Equations 1 to 3 below.

P1=P0−δ (Equation 1)

r1=r0−d tan θ (Equation 2)

D1=2(P0−δ)/π(r0−d tan θ)² (Equation 3)

The raw filament that has passed through the raw filament passage 11ₙ, which is the farthest of the raw filament passages 11₁ to 11ₙ from the laser irradiation device 9, is irradiated with the focused beam having a power Pn, a radius rn, and a power density Dn as defined in Equations 4 to 6 below.

Pn=P0−nδ (Equation 4)

rn=r0−nd tan θ (Equation 5)

Dn=2(P0−nδ)/π(r0−nd tan θ)² (Equation 6)

Here, the number of raw filaments (=the number of raw filament passages) n and intervals d between the raw filament passages depend on the properties of the apparatus 1 for producing ultrafine fibers. The power reduction amount δ depends on the properties, feed speed, and the like of the raw filaments, and may be measured in advance through experiments and/or the like. Thus, when the laser oscillator 91 emits a laser beam having the power P0 and radius r0, determining the focusing angle θ that makes D1 (Equation 3) equal to Dn (Equation 6) allows the raw filaments to be irradiated with the laser beam at substantially equalized power densities. Accordingly, the beam converter 93 is adapted to convert the laser beam emitted from the laser oscillator 91 into a focused beam having the focusing angle θ determined as described above. In a non-limiting example, the focusing angle θ may be set to 0.5 to 10 mrad, preferably 1 to 5 mrad.

Additionally, the power P0 and diameter (radius r0) of the laser beam upon being emitted from the laser oscillator 91 may be changed so as to adjust the substantially equalized power densities of the laser beam applied to the raw filaments. Here, adjusting the substantially equalized power densities of the laser beam applied to the raw filaments will change the molten states of the raw filaments, and will thus change the average diameter (diameter distribution) of the resulting (produced) ultrafine fibers.

Next, the operation of the laser irradiation device 9 will be described. While the apparatus 1 for producing ultrafine fibers is in operation, the laser oscillator 91 emits a laser beam having properties (power P0 and radius r0) previously determined based on an input operation of the operator or the like in accordance with the type of the raw filaments and the raw filament feed speed of the raw filament feeder 3, and the beam converter 93 converts the laser beam emitted from the laser oscillator 91 into the focused beam based on the input operation of the operator or the like. The focusing angle θ of the focused beam after conversion has a value determined in advance as described above. In addition, the controller 95 monitors the power P_{OUT} of the laser beam after transmission measured by the light power sensor 17.

The controller 95 compares the power P_{OUT} of the laser beam after transmission measured by the light power sensor 17 with preset thresholds (upper limit threshold Pth1 and lower limit threshold Pth2). The upper limit threshold Pth1 may be set to, for example, (P0−nδ)+α, and the lower limit threshold Pth2 may be set to, for example, (P0−nδ)−α.

When the power P_{OUT} of the laser beam after transmission measured by the light power sensor 17 exceeds the upper limit threshold Pth1, the controller 95 controls the laser oscillator 91 so as to reduce the power P0 or increase the diameter of the laser beam upon being emitted from the laser oscillator 91. This is because the power P_{OUT} of the laser beam after transmission exceeding the upper limit threshold Pth1 indicates that the actual power reduction amount δr of the laser beam caused by oscillation and vibration of each raw filament may be smaller than the power reduction amount δ used for determining the focusing angle θ of the focused beam, and thus indicates that the power density of the laser beam applied to each raw filament may deviate from the expected value (may be higher than the expected value).

On the other hand, when the power P_{OUT} of the laser beam after transmission measured by the light power sensor 17 falls below the lower limit threshold Pth2,the controller 95 controls the laser oscillator 91 so as to increase the power P0 or reduce the diameter of the laser beam upon being emitted from the laser oscillator 91. This is because the power P_{OUT} of the laser beam after transmission below the lower limit threshold Pth2 indicates that the actual power reduction amount δr of the laser beam caused by oscillation and vibration of each raw filament may be greater than the power reduction amount δ used for determining the focusing angle θ of the focused beam, and thus indicates that the power density of the laser beam applied to each raw filament may deviate from the expected value (may be lower than the expected value).

As described above, the controller 95 monitors the power P_{OUT} of the laser beam after transmission measured by the light power sensor 17 and controls the laser oscillator 91 accordingly as necessary. This allows the power densities of the laser beam applied to the raw filaments to be maintained equalized and constant while the apparatus 1 for producing ultrafine fibers is in operation, and prevents or reduces variation among the ultrafine fibers to be produced.

As described above, the apparatus 1 for producing ultrafine fibers according to this embodiment includes the laser irradiation device 9 for irradiating the raw filaments with a laser beam after the raw filaments have passed through the raw filament passages 11₁ to 11ₙ, and the laser irradiation device 9 includes the laser oscillator 91 configured to emit a laser beam parallel to the direction of the row of the raw filament passages 11₁ to 11ₙ, and the beam converter 93 configured to convert the laser beam emitted from the laser oscillator 91 into a focused laser beam having a diameter decreasing as the distance from the laser oscillator 91 increases. This allows the raw filaments to be irradiated with the laser beam at substantially equalized power densities by compensating for laser power reductions caused by the oscillated and vibrated raw filaments. Thus, the apparatus 1 for producing ultrafine fibers is capable of reliably producing a plurality of ultrafine fibers from a plurality of raw filaments using just a single laser irradiation device 9.

The laser oscillator 91 is configured such that at least one of the power and diameter of the laser beam emitted therefrom is variable. The beam converter 93 includes the entrance lens 93a and the exit lens 93b, and is configured such that the focusing property of the focused laser beam is variable by adjustment of the distance between the entrance lens 93a and the exit lens 93b. Thus, the power density of the laser beam applied to each raw filament may be adjusted in accordance with the type, feed speed, and the like of the raw filaments, for example. Furthermore, the average diameter of the ultrafine fibers to be produced from the raw filaments may also be changed by adjustment of the power density.

The laser irradiation device 9 includes the controller 95 configured to control the laser oscillator 91 in accordance with the power P_{OUT} of the laser beam after transmission, which is measured after the laser beam output from the laser irradiation device 9 has been transmitted across the oscillated and vibrated raw filaments. This allows the controller 95 to adjust the power P0 or the diameter of the laser beam upon being emitted from the laser oscillator 91 as necessary, and thus to maintain the power densities of the laser beam applied to the raw filaments equalized and constant. Thus, it is possible to prevent or reduce variation among the ultrafine fibers to be produced.

In the above embodiment, the raw filament passages 11₁ to 11ₙ are arranged at regular intervals. However, the present invention is not limited to this, and the raw filament passages 11₁ to 11ₙ may alternatively be arranged at irregular intervals. It should be noted, however, that arranging the raw filament passages 11₁ to 11ₙ at irregular intervals allows the raw filaments to be irradiated with the laser beam at less equalized power densities than arranging the raw filament passages 11₁ to 11ₙ at regular intervals. Thus, it is preferable to arrange the raw filament passages 11₁ to 11ₙ at regular intervals. In the above embodiment, the controller 95 controls the laser oscillator 91 in accordance with a measurement output from the light power sensor 17 (that is, in accordance with the power P_{OUT} of the laser beam after transmission). However, the present invention is not limited to this, and the controller 95 may control the beam converter 93 instead of the laser oscillator 91 or in addition to the laser oscillator 91 in accordance with a measurement output from the light power sensor 17. Furthermore, the laser beam output from the laser irradiation device 9 is not necessarily a circular beam, and it may be a deformed beam (such as a horizontally long elliptical beam).

### EXAMPLES

Hereinafter, the present invention will be specifically described by way of Examples. It should be noted that Examples below are not intended to limit the present invention. Each of the apparatuses for producing ultrafine fibers of Examples 1 and 2 and Comparative Examples 1 and 2 described below used polypropylene multifilaments as the raw filaments. The apparatus for producing ultrafine fibers included 60 raw filament passages, each of which includes a straightening portion having an inner diameter ID set to 1 mm and which are arranged at intervals of 10 mm (that is, the apparatus for producing ultrafine fibers included the feed chamber 5 and the drawing chamber 7 communicating with each other through 60 raw filament passages 11₁ to 11₆₀).

### Example 1

In Example 1, by adjusting the feed speed of the raw filaments and the settings for the laser irradiation device 9, the apparatus 1 for producing ultrafine fibers described above was set up to produce ultrafine fibers having a diameter of approximately 300 nm. In Example 1, the power P0 of the focused beam upon being output from the laser irradiation device 9 was 1100 W, the initial radius r0 of the focused beam immediately after being output from the laser irradiation device 9 was 10 mm, and the focusing angle θ of the focused beam output from the laser irradiation device 9 was 3.3 mrad.

### Example 2

In Example 2, the radius of the focused beam irradiated to the raw filaments that passed through the raw filament passages was reduced (power density was increased) as compared to Example 1. In Example 2, the power P0 of the focused beam upon being output from the laser irradiation device 9 was 1100 W, the initial radius r0 of the focused beam immediately after being output from the laser irradiation device 9 was 5 mm, and the focusing angle θ of the focused beam output from the laser irradiation device 9 was 2.5 mrad.

### Comparative Example 1

The apparatus for producing ultrafine fibers of Comparative Example 1 included a second laser irradiation device configured to output a collimated beam in place of the laser irradiation device 9 configured to output a focused beam. In Comparative Example 1, by adjusting the feed speed of the raw filaments and the settings for the second laser irradiation device, the apparatus for producing ultrafine fibers was set up to produce ultrafine fibers having a diameter of approximately 300 nm. The second laser irradiation device may have a configuration similar to that of the laser irradiation device 9 except for including a collimator in place of the beam converter 93. In Comparative Example 1, the power P0 of the collimated beam upon being output from the second laser irradiation device was 1140 W, and the radius r of the collimated beam output from the second laser irradiation device was 6 mm.

### Comparative Example 2

The apparatus for producing ultrafine fibers of Comparative Example 2 included a third laser irradiation device configured to output a flat-top beam (square beam) in place of the laser irradiation device 9 configured to output a focused beam. In Comparative Example 2, by adjusting the feed speed of the raw filaments and the settings for the third laser irradiation device, the apparatus for producing ultrafine fibers was set up to produce ultrafine fibers having a diameter of approximately 300 nm. The third laser irradiation device may have a configuration similar to that of the laser irradiation device 9 except for including a flat-top beam shaper in place of the beam converter 93. In Comparative Example 2, the power P0 of the flat-top beam upon being output from the third laser irradiation device was 1125 W, and the beam size at the image formation position of the flat-top beam output from the third laser irradiation device was 25 mm×3 mm.

### Comparison of Examples 1 and 2 and Comparative Examples 1 and 2

In a first experiment, using Examples 1 and 2 and Comparative Examples 1 and 2, ultrafine fibers were produced. In Comparative Example 2, the image formation position of the flat-top beam was set in the middle of the row of the raw filament passages; that is, set at the location corresponding to the 30th raw filament passages 11₃₀ from the third laser irradiation device. In Examples 1 and 2, the raw filaments that passed through 60 raw filament passages 11₁ to 11₆₀ were satisfactorily melted so that each of Examples 1 and 2 produced 60 ultrafine fibers. On the other hand, in Comparative Examples 1 and 2, the raw filaments that passed through the 45th and subsequent raw filament passages 11₄₅ to 11₆₀ from the second or third laser irradiation device were not satisfactorily melted, so that each of Comparative Examples 1 and 2 produced no more than approximately 40 ultrafine fibers. Therefore, it was confirmed that when the power P0 of the laser beam upon being output from the laser irradiation device was substantially the same (approximately 1100 W, herein) among Examples 1 and 2 and Comparative Examples 1 and 2, Examples 1 and 2 (focused beam) could produce a larger number of ultrafine fibers than Comparative Example 1 (collimated beam) and Comparative Example 2 (flat-top beam).

In a second experiment, ultrafine fibers were produced using Examples 1 and 2 by feeding raw filaments to all the 60 raw filament passages 11₁ to 11₆₀, and ultrafine fibers were produced using Comparative Examples 1 and 2 by feeding raw filaments to the first to 40th raw filament passages 11₁ to 11₄₀ from the second or third laser irradiation device. Then, for each of Examples 1 and 2 and Comparative Examples 1 and 2, the average diameter D of the produced ultrafine fibers and energy use efficiency η were calculated. Specifically, the average fiber diameter D was calculated by photographing the web W resulting from ultrafine fiber accumulation on the conveyor 13 with a scanning electron microscope, then counting the number and measuring the diameters of all the ultrafine fibers in the photograph thus obtained, and dividing the sum of the diameters of the ultrafine fibers by the number of ultrafine fibers. The energy use efficiency η was calculated, based on the power P0 of the laser beam upon being output from the laser irradiation device and the power P_{OUT} after transmission measured by the light power sensor 17, by Equation 7 below.

η(%)={(P0−P_{OUT})/P0}×100 (Equation 7)

FIG. 5 shows the results of the second experiment. As shown in FIG. 5, it was confirmed that Examples 1 and 2 (focused beam) had a far higher energy use efficiency η than Comparative Example 1 (collimated beam) and Comparative Example 2 (flat-top beam), and specifically that the energy use efficiency η of Examples 1 and 2 was three times or more the energy use efficiency η of Comparative Example 1 and twice or more the energy use efficiency η of Comparative Example 2. Furthermore, comparison of the average diameter of the ultrafine fibers produced by Example 1 with the average diameter of the ultrafine fibers produced by Example 2 shows that the average diameter of the produced ultrafine fibers tends to decrease as the power density of the laser beam applied to each raw filament increases (as the beam diameter decreases).

### REFERENCE SYMBOL LIST

1 Apparatus for producing ultrafine fibers
3 Raw filament feeder
5 Feed chamber
7 Drawing chamber
9 Laser irradiation device
11₁ to 11ₙ Raw filament passage
17 Light power sensor
91 Laser oscillator
93 Beam converter
95 Controller

1. An apparatus for producing ultrafine fibers, configured to produce ultrafine fibers by melting and drawing raw filaments, the apparatus comprising:
a plurality of raw filament passages arranged in a straight row; and
a laser irradiation device for irradiating a plurality of raw filaments with a laser beam so as to melt, oscillate and vibrate the plurality of raw filaments after the plurality of raw filaments have passed through the respective raw filament passages together with airstreams,
wherein the laser irradiation device is configured to output a focused laser beam having a diameter decreasing as distance from the laser irradiation device increases, and having a beam axis parallel to a direction of the row of the plurality of raw filament passages.

2. The apparatus for producing ultrafine fibers according to claim 1,
wherein the laser irradiation device includes:
a laser oscillator configured to emit a laser beam parallel to the direction of the row of the plurality of raw filament passages; and
a beam converter configured to convert the laser beam emitted from the laser oscillator into the focused laser beam having a diameter decreasing as distance from the laser oscillator increases.

3. The apparatus for producing ultrafine fibers according to claim 2,
wherein the laser oscillator is configured such that at least one of a power and a diameter of the laser beam emitted from the laser oscillator is variable, and
wherein the beam converter includes a plurality of lenses, and is configured such that a focusing property of the focused laser beam is variable by adjustment of distance between the lenses.

4. The apparatus for producing ultrafine fibers according to claim 3, further comprising
a power sensor disposed at a position facing the laser irradiation device across the plurality of raw filament passages, and configured to measure a power of the laser beam after the laser beam emitted from the laser oscillator has been transmitted across the plurality of oscillated and vibrated raw filaments,
wherein the laser irradiation device further includes a controller configured to control at least one of the laser oscillator and the beam converter in accordance with a measurement output from the power sensor.

5. The apparatus for producing ultrafine fibers according to claim 1, wherein the beam axis of the focused laser beam passes across axes of the raw filament passages at locations spaced a predetermined distance from the raw filament passages.

6. The apparatus for producing ultrafine fibers according to claim 1, wherein the focused laser beam has a focusing property that compensates for laser power reductions caused by the plurality of oscillated and vibrated raw filaments so that the plurality of raw filaments are irradiated with the laser beam at equalized power densities.

7. The apparatus for producing ultrafine fibers according to claim 1,
wherein the plurality of raw filament passages are arranged at regular intervals, and
wherein the focused laser beam is adapted to have equalized power densities at locations corresponding to the respective raw filament passages.

8. The apparatus for producing ultrafine fibers according to claim 1, further comprising:
a feed chamber in which a raw filament feeder is disposed, the raw filament feeder being configured to feed the plurality of raw filaments; and
a drawing chamber in which the plurality of raw filaments are drawn, the drawing chamber being set at a pressure lower than a pressure in the feed chamber, and communicating with the feed chamber through the plurality of raw filament passages,
wherein the laser irradiation device is configured to irradiate the plurality of raw filaments with a laser beam and thereby melt, oscillate, vibrate, and draw the plurality of raw filaments in the drawing chamber, after the plurality of raw filaments have passed through the respective raw filament passages together with the airstreams and then entered the drawing chamber.

9. The apparatus for producing ultrafine fibers according to claim 8, wherein the raw filament feeder is further configured to feed the raw filaments at a variable speed.
